(19) United States
(12) Patent Application Publication
(10) Pub. No.: US 2026/0063097 A1
(43) Pub. Date: Mar. 5, 2026

(54) PROCESS FOR FAST START OF A HYDROGEN GENERATOR

(71) Applicant: Precision Combustion, Inc., North Haven, CT (US)

(72) Inventors: Curtis Morgan, South Glastonbury, CT (US); Sam Whiteley, New York, NY (US); Timothy LaBreche, Chelsea, MI (US); Subir Roychoudhury, Madison, CT (US); Saurabh Vilekar, Woodbridge, CT (US)

(21) Appl. No.: 18/955,365

(22) Filed: Nov. 21, 2024

Related U.S. Application Data
(60) Provisional application No. 63/687,755, filed on Aug. 27, 2024.

(51) Int. Cl. F02N 19/06; C01B 3/34; C01B 3/36

(52) U.S. Cl. CPC F02N 19/06; C01B 3/342; C01B 3/36; C01B 2203/0261; C01B 2203/085; C01B 2203/1035; C01B 2203/1235; C01B 2203/80

(57) ABSTRACT

A process of quickly starting a hydrogen generator from cold conditions. The generator, which converts a fuel and an oxidant under catalytic partial oxidation conditions into a mixture of hydrogen and carbon monoxide, is intended for onboard integration with an internal combustion engine (ICE) of a transportation vehicle. Fast start of the hydrogen generator allows for rapid hydrogen augmentation of the ICE with the advantages of a more stable combustion and a reduction in hydrocarbon and NOx emissions.

### CROSS-REFERENCE TO RELATED APPLICATIONS

This application claims benefit of U.S. provisional application no. 63/687,755, filed Aug. 27, 2024, the contents of which in their entirety are incorporated herein by reference.

### GOVERNMENT RIGHTS

This invention was made with support from the U.S. government under Contract No. DE-SC0013709, sponsored by the Department of Energy. The U.S. government holds certain rights in this invention.

### FIELD OF THE INVENTION

This invention pertains to a process of starting a hydrogen generator from cold conditions. More specifically, this invention pertains to a process of fast-starting from cold conditions a catalytic partial oxidation reactor capable of reforming a mixture of a fuel and an oxidant into a mixture of hydrogen and carbon monoxide. As used herein, the term “cold conditions” or “cold start” refer to starting the hydrogen generator at ambient temperature, typically, a temperature between about −40° F. (−40° C.) and about 115° F. (46° C.).

### BACKGROUND OF THE INVENTION

On starting an internal combustion engine of a transportation vehicle, a significant quantity of undesirable emissions are released in the first 30 seconds (30 sec) up to about one minute (1 min) of operation, that is, when the engine is cold. Once warmed, the vehicle needs to be driven hundreds of miles before reaching the same volume of emissions as is released within the first minute after a cold start. The emissions result, in part, from lean fuel-air mixtures required for stable engine operation during the cold start. Moreover, at cold start-up temperatures catalytic converters designed to neutralize post-combustion hydrocarbons emissions operate less efficiently as compared with the efficiency achieved at steady state operating temperatures.

The Environmental Protection Agency employs Federal Test Procedures (EPA FTP's) to set acceptable tailpipe emissions and fuel efficiency standards for vehicular urban and highway driving, where currently as much as ninety percent of hydrocarbons emissions is measured in the initial minute of vehicle operation. Accordingly, later emissions must be significantly reduced and later efficiency significantly increased to compensate for the higher emissions during the cold start period. Additional controls to reduce later emissions are reaching a point of diminishing returns. Improvements in later emissions make only a small incremental improvement in overall emissions. However, if the vehicle could be started from cold conditions and emissions brought under control in less than six seconds, the EPA FTP standards for acceptable emissions and fuel efficiency might be further reduced for significant environmental benefits.

The skilled person will appreciate that additional improvements in cold starting an internal combustion engine are constrained by the inherent size of an engine block and by the heat input required for the engine block to reach a steady state operating temperature. Moreover, improvements in cold-starting an internal combustion engine likely require a new fueling strategy for stable operation, specifically, a strategy of a fuel-rich start, which however may cause disadvantageous wall wetting and oil dilution with fuel as well as higher fuel consumption. Consequently, any further improvements in fuel emissions and fuel efficiency in operating transportation vehicles are challenged by the inherent size, design, and operational needs of present-day internal combustion engines.

Catalytic partial oxidation reactors, also known as “hydrogen generators,” can be integrated onboard a transportation vehicle to augment its liquid fuel with hydrogen. Admixture of hydrogen to the fuel improves fuel efficiency and combustion stability and reduces hydrocarbons emissions. Based on information from automotive original equipment manufacturers (OEM's), however, an onboard hydrogen generator should desirably start from cold conditions in less than about 6 seconds for acceptable integration with a vehicular internal combustion engine to reap the benefits that hydrogen augmentation provides. An onboard hydrogen generator capable of fast starting would facilitate the very improvements that OEM's seek for transportation vehicles, but which are presently hampered by an engine's intrinsic size.

### SUMMARY OF THE INVENTION

This invention provides for a method of starting a hydrogen generator from cold conditions comprising:
(a) providing a catalytic partial oxidation reactor having disposed therein a substrate having a partial oxidation catalyst supported thereon; and further comprising a heat source disposed in proximity to a front face of the substrate;
(b) energizing the heat source at a power equal to about 5 to 15 percent of a power (energy) input to the reactor based on a Lower Heating Value (LHV) and feed flow rate of a selected fuel;
(c) essentially simultaneously with step (b) initiating a flow of an oxidant and a flow of the selected fuel at an O/C ratio between about 0.8/1 and 1.3/1; and
(d) upon observation of an incipient exotherm indicative of hydrogen generation, de-energizing the heat source.

The process of this invention provides for fast starting a hydrogen generator for integration with an internal combustion engine employed in a transportation vehicle. As one technical advantage, the process of this invention provides for fast starting the hydrogen generator in less than 6 seconds from cold start conditions, and preferably, less than 5 seconds, and more preferably, between 1 and 4 seconds. In yet another technical advantage, the process of this invention minimizes detrimental deposits of fuel on walls and parts of the hydrogen generator and internal combustion engine, despite using fuel and oxygen stoichiometries in a fuel-rich regime during the cold start operation. As another advantage, the process of this invention provides for fuel and oxidant flow strategies that result in stable operation during cold start conditions of both the hydrogen generator and an associated vehicular internal combustion engine. As another technical advantage, the process of this invention results in reduced hydrocarbons emissions and improved fuel efficiency in the critical first 30 seconds of vehicular engine operation. In addition to integration with an internal combustion engine, the process of this invention is applicable to other systems, such as thermal, catalytic, and electrocatalytic systems, needing near-instantaneous hydrogen as feed. One such application is a fuel cell power generation system.

### BRIEF DESCRIPTION OF THE DRAWINGS

FIG. 1 depicts graphs plotting parameters of Temperature, Fuel Flow and Air Flow versus Time for an embodiment of the process of this invention.

FIG. 2 depicts graphs plotting parameters of Temperature, Fuel Flow, Air Flow, and Oxygen Concentration versus Time for an embodiment of the process of this invention.

### DETAILED DESCRIPTION OF THE INVENTION

As used herein, the words “start” and “start-up” refer to a time period beginning at a time zero (t=0) when a heat source is activated, thereby initiating operation of the hydrogen generator, and ending at a time when the generator operates self-sufficiently without the heat source.

As used herein, the terms “cold start” and “cold conditions” refer to starting a hydrogen generator from ambient temperature, for example, typically a temperature between about −40° F. (−40° C.) and about 115° F. (46° C.).

When referring to “fast start”, this invention references a time period specifically of less than 6 seconds, more preferably less than 5 seconds, during which time the hydrogen generator is starting up.

As used herein, the term Lower Heating Value (LHV) of the fuel, is defined as the amount of heat released by combusting a specific quantity of the fuel, initially taken at 25° C., and returning the temperature of the combustion products to 150° C., which assumes the latent heat of vaporization of water in the reaction products is not recovered. LHV is typically measured in British thermal units per pound (BTU/lb) or its equivalent megajoules per kilogram (MJ/kg). It should be appreciated that power (energy) is measured in units of “joules per second” (J/sec); and therefore, power (energy) input to the hydrogen generator based on the LHV and feed flow rate of the selected fuel can be correlated to the power output of the heat source.

As used herein, the inputs of oxidant and fuel to the hydrogen generator are best described by an oxygen to carbon ratio (O/C), wherein “O” represents a number of oxygen atoms in the oxidant fed to the reactor and “C” represents a number of carbon atoms in the fuel fed to the reactor.

In some preferred embodiments, this invention provides for a method of starting a hydrogen generator from cold conditions comprising:
(a) providing a catalytic partial oxidation reactor having disposed therein a metal mesh substrate having a partial oxidation catalyst supported thereon; and further comprising a heat source disposed in proximity to a front face of the metal mesh substrate;
(b) energizing the heat source at a power equal to about 5 to 15 percent of a power (energy) input to the reactor based on a Lower Heating Value (LHV) and feed flow rate of a selected fuel;
(c) essentially simultaneously with step (b) initiating a flow of oxidant and a flow of the selected fuel at an O/C ratio between about 0.8/1 and 1.3/1; and
(d) upon observation of an incipient exotherm indicative of hydrogen generation, de-energizing the heat source.

In some preferred illustrative embodiments of this invention, the aforementioned metal mesh has an ultra-short-channel-length ranging from 25 microns to 500 microns.

In some illustrative embodiments of any and all of the aforementioned embodiments, the partial oxidation catalyst is selected from the Group VIII transition metals of the Periodic Table.

In some illustrative embodiments of any and all of the aforementioned embodiments, the substrate is provided in the shape of a cylindrical coiled mesh. In yet some illustrative embodiments of the aforementioned embodiment, the heat source is disposed within a space defined by an inner diameter and length of the cylindrical coiled mesh, and the mesh is therefore wrapped around the heat source.

In some illustrative embodiments of any and all of the aforementioned embodiments, the heat source is a glow plug.

In some illustrative embodiments of any and all of the aforementioned embodiments, the cold start is initiated at a temperature in a range from −40° C. to about +46° C.

In some illustrative embodiments of any and all of the aforementioned embodiments, the heat source is energized at a power equal to about 8 to 12 percent of a power (energy) input to the reactor based on the Lower Heating Value (LHV) and feed flow rate of a selected fuel.

In some illustrative embodiments of any and all of the aforementioned embodiments, the oxidant flow is initiated within 0.2 second of initiation of the fuel flow.

In some illustrative embodiments of any and all of the aforementioned embodiments, the cold start is accomplished in less than 6 seconds, preferably, less than 5 seconds, and more preferably between 1 and 4 seconds.

In some illustrative embodiments of any and all of the aforementioned embodiments, the incipient exotherm is measured by means of at least one thermocouple disposed on or near the substrate or measured by means of an oxygen sensor disposed in an effluent stream at the outlet of the hydrogen generator (catalytic partial oxidation reactor).

In some illustrative embodiments of any and all of the aforementioned embodiments, after reaching the incipient exotherm, the flow of oxidant is decreased to an O/C ratio between 0.3/1 and 0.6/1 to stabilize temperature.

In some illustrative embodiments of any and all of the aforementioned embodiments, after temperature stabilizes, the flow of oxidant is increased to a steady state operating O/C ratio between 0.9/1 and 1.5/1 so as to maintain a catalyst temperature between 800° C. and 1,000° C.

The hydrogen generator employed in the process of this invention may be any catalytic partial oxidation (CPOX) reactor providing for flameless conversion of a mixture of fuel and oxidant into a gaseous product mixture comprising hydrogen and carbon monoxide. Generally, the CPOX reactor comprises a housing enclosing a reaction zone. The housing will be fitted with an inlet for introducing a fuel, an inlet for introducing an oxidant, and an outlet for exiting an effluent product stream. The housing will enclose a mixer if needed, a heat source, and a substrate positioned in close proximity to the heat source. To facilitate the process of this invention, the substrate should comprise a low thermal mass, high thermal conductivity material having a partial oxidation catalyst supported thereon. Suitable preferred partial oxidation reactors include those described in the following patent documents: U.S. Pat. Nos. 7,976,594, 8,557,189, WO 2004/060546, and US 2011/0061299, all being incorporated herein by reference.

More specifically, the fuel is fed from a fuel supply, such as a fuel tank, through a fuel inlet, and optionally through a mixer if one is employed, into the CPOX reaction zone. The fuel inlet comprises any conventional device for feeding or dispensing the fuel, for example, a nozzle, atomizer, vaporizer, injector, or flow meter. The fuel injector also functions to quantify (or meter) the fuel fed to the reactor. In this invention, essentially simultaneously the oxidant is fed into the reactor through an oxidant inlet comprising again any conventional dispensing device, for example, a nozzle, injector, or flow meter.

The catalytic partial oxidation reactor may comprise a mixer disposed upstream of the substrate, the mixer including swirler vanes and baffles, which facilitate mixing the fuel and the oxidant as well as facilitating atomization of a liquid fuel when such is employed. In one other embodiment, the mixer comprises a combination of a pulsed electromagnetic liquid fuel injector and a pulsed oxidant injector, which feed the liquid fuel and the oxidant into an atomizer that thoroughly atomizes the liquid fuel and mixes it with the oxidant. This combined dual injector-atomizer device is described in U.S. Pat. No. 8,439,990, incorporated herein by reference. If a gaseous fuel is employed, there is no imperative to use the atomizer.

In a preferred embodiment, the substrate comprises a metal mesh, constructed as a reticulated net or screen, comprising a plurality of pores, cell, or channels, more preferably having an ultra-short-channel-length as detailed hereinafter. In one preferred embodiment, the mesh is provided in a coiled configuration of cylindrical shape having an inner diameter and a larger outer diameter such that reactants flowing there through move along a radial flow path from an inlet along the inner diameter to an outlet along the outer diameter of the coil. In another embodiment the mesh is suitably provided as a mesh sheet or a plurality of stacked mesh sheets with a bulk flow from an inlet end of the stack to an outlet end of the stack. In the preferred embodiments, the configuration of the substrate provides for a plurality of void volumes in random order, that is, empty spaces having essentially no regularity along the flow path from the reactor inlet to the reactor outlet.

The substrate is constructed from a metallic material providing a high thermal conductivity while also being durable under the temperatures at which the partial oxidation reactor operates, generally in a range from about 750° C. to about 1,200° C. Suitable metal materials of construction providing sufficient thermal conductivity include, without limitation, nickel-chromium-iron alloys, iron-chromium alloys, and iron-chromium-aluminum alloys.

In some preferred exemplary embodiments, the substrate comprises a MICROLITH® brand ultra-short-channel-length metal mesh (Precision Combustion, Inc., North Haven, Connecticut, USA), a description of which is found, for example, in U.S. Pat. No. 5,051,241, incorporated herein by reference. Generally, this mesh comprises short channel length, low thermal mass monoliths, which contrast with prior art monoliths having longer channel lengths. For purposes of this invention, the term “ultra-short-channel-length” refers to a channel length in a range from about 25 microns (μm) (0.001 inch) to about 500 μm (0.02 inch). In contrast, the term “long channels” pertaining to prior art monoliths refers to channel lengths of greater than about 5 mm (0.20 inch) upwards of 127 mm (5 inches). In this invention the term “channel length” is taken as the distance along a pore or channel measured from an inlet on one side of the mesh sheet to an outlet on the opposite side of the mesh sheet. (This measurement is not to be confused with, and is different from, the total length of the reaction path through the substrate from reactant inlet to product outlet.) In another embodiment, the channel length is no longer than the diameter of the elements from which the mesh is constructed; thus, the channel length may range from 25 μm (0.001 inch) up to about 100 μm (0.004 inch) and preferably not more than about 350 μm (0.014 inch). In view of this ultra-short channel length, the contact time of reactants with the mesh and catalyst supported thereon advantageously ranges from about 5 milliseconds (5 msec) to about 350 msec.

The MICROLITH brand ultra-short-channel-length mesh typically comprises from about 100 to about 1,000 or more flow channels per square centimeter. More specifically, each layer of mesh typically is configured with a plurality of channels or pores having a diameter ranging from about 0.25 millimeters (mm) to about 1.0 mm, with a void space greater than about 60 percent, preferably up to about 80 percent or more. A ratio of channel length to diameter is generally less than about 2:1, preferably less than about 1:1, and more preferably, less than about 0.5:1. MICROLITH brand meshes can be manufactured in the form of woven wire screens, pressed metal screens; or they can be manufactured by perforation and expansion of a thin metal sheet as disclosed in U.S. Pat. No. 6,156,444, incorporated herein by reference; or alternatively manufactured by 3-D printing or by a lost polymer skeleton method.

The MICROLITH brand mesh having the ultra-short-channel-length facilitates packing more active surface area into a smaller volume and provides increased active surface area and lower pressure drop, as compared with prior art monolithic substrates. Whereas in prior art honeycomb monoliths having conventional long channels where a fully developed boundary layer is present over a considerable length of the channels, in contrast, the ultra-short-channel-length characteristic of the mesh of this invention avoids boundary layer buildup. Since heat and mass transfer coefficients depend on boundary layer thickness, avoiding boundary layer buildup enhances transport properties. Employing the ultra-short-channel-length mesh, such as the MICROLITH brand thereof, to control and limit the development of a boundary layer of a fluid passing there through is described in U.S. Pat. No. 7,504,047, which is a Continuation-In-Part of U.S. Pat. No. 6,746,657 to Castaldi, both patents incorporated herein by reference. The preferred MICROLITH brand of ultra-short-channel-length mesh also advantageously provides for a light-weight portable size, a high throughput, a high one-pass yield of hydrogen-containing partial oxidation product, a low yield of coke and coke precursors, and an acceptably long catalyst lifetime, as compared with alternative substrates including ceramic monolith and pelleted substrates.

The substrate disposed within the partial oxidation reactor supports a catalyst capable of facilitating partial oxidation reactions to form synthesis gas comprising hydrogen and carbon monoxide. A suitable partial oxidation catalyst comprises at least one metal of Group VIII of the Periodic Table of the Elements, including iron, cobalt, nickel, ruthenium, rhodium, palladium, osmium, iridium, platinum, and mixtures thereof. The deposition of the Group VIII metal(s) onto the substrate is implemented by methods well known in the art. Alternatively, finished catalysts comprising Group VIII metal(s) supported on the MICROLITH brand mesh substrate are available from Precision Combustion, Inc., North Haven, CT.

The catalytic partial oxidation reactor further comprises a heat source disposed in proximity to a front face of the substrate; the “front face” of the substrate being the leading area of the substrate that first contacts the upstream, incoming flows of fuel and oxidant. The heat source typically comprises a resistive glow plug heating element or a resistive gauze or tape. The heat source is located typically within the catalytic partial oxidation reactor in any convenient location near the front face of the substrate, facilitating efficient heat transfer into the substrate without unacceptable heat losses to other parts of the reactor. Such locations can include in one embodiment direct solid-to-solid contact of the heat source with the substrate. In another embodiment, the heat source is spaced-apart from but in adjacent or nearby location vis-à-vis the substrate. In a preferred exemplary embodiment, the substrate comprises a metal mesh that is coiled cylindrically around the heat source.

The skilled person will appreciate that the fuel supplied to the hydrogen generator comprises any gaseous or liquid fuel obtained, for example, from a petroleum, biofuel, or synthetic resource, or any mixture thereof. Acceptable gaseous fuels include, for example, methane, natural gas, ethane, ethylene, propane, propylene, butane, butylene and mixtures thereof. Liquid fuels include, generically, a single paraffinic, cycloaliphatic, or aromatic hydrocarbon, or alternatively, a mixture of paraffinic, cycloaliphatic, and aromatic hydrocarbons. Suitable liquid fuels include those derivable from petroleum and biomass resources and those prepared synthetically by Fisher-Tropsch processes; non-limiting examples of which include kerosene, diesel, jet propulsion fuels, such as JP-8, JP-5, and Jet A, as well as similar logistic fuels and corn-based biofuels, and mixtures of Fisher-Tropsch hydrocarbons and alcohols.

The oxidant supplied to the hydrogen generator comprises any chemical compound capable of converting the fuel into a partially oxidized mixture of hydrogen and carbon monoxide (syngas). Suitable oxidants include, without limitation, essentially pure oxygen, mixtures of oxygen and nitrogen, including air, and mixtures of oxygen and an inert gas, such as helium or argon. Preferably, the oxidant is air.

The skilled person will appreciate that in the prior art, a hydrogen generator like the above-described CPOX reactor typically was started from cold conditions by first energizing the heat source to begin heating the substrate-catalyst composite, but without feeding fuel or oxidant to the reactor; then initiating a nominal flow of fuel after reaching light-off temperature; and thereafter initiating the flow of oxidant after 1-2 sec delay, generally, in a highly fuel-rich regime on the order of an O/C ratio between 0.2/1 and 0.6/1. This typically provided for a cold-start in no less than 6 seconds, and more typically from 6 to 10 seconds or even a longer time up to 20 to 30 seconds. Once the reaction was self-sustaining, the heat source was de-energized and the O/C ratio was increased to a steady state operating range, between about 0.9/1 and 1.5/1. In contrast, the present invention changes the start-up protocol in several aspects that, taken together in combination, unexpectedly result in a cold fast-start in less than 6 seconds, preferably, less than 5 seconds, and more preferably, between 1 and 4 seconds. The protocol of the invention provides for reduced hydrocarbons emissions in the first critical minute of operation. As a first condition in achieving the improved cold start, the heat source is powered up at a higher percentage of the power (energy) input to the CPOX reactor based on LHV and feed flow rate of the selected fuel. As a second condition and simultaneously with energizing the heat source, the fuel and oxidant flows are started together. As a third condition, the O/C ratio of the oxidant and fuel flows during the cold start is significantly higher than normal, now straddling fuel-rich and fuel-lean regimes for partial reforming, specifically, between 0.8/1 to 1.3/1.

Accordingly, in the cold-start process of this invention, at time zero (t=0), when the hydrogen generator is in a cold start condition, the heat source is energized at a power equal to about 5 to 15 percent of a power (energy) input to the reactor based on the Lower Heating Value (LHV) and feed flow rate of the selected fuel. “Lower Heating Value” is defined as the quantity of heat released by combusting a specific quantity of fuel, initially taken at 25° C., and returning the temperature of the combustion products to 150° C., which assumes the latent heat of vaporization of water in the reaction products is not recovered. Lower Heating Values of various fuels are readily available in the art, as found for example at the Department of Energy, Alternative Fuels Data Center website: https://afdc.energy.gov/fuels/properties. Conventional gasoline, for example, has an LHV of 43.44 MJ/kg; low sulfur diesel has a LHV of 42.60 MJ/kg. The feed fuel flow rate to the reactor is typically given in units of kilograms per second (kg/s) and will depend upon the fuel selected, and the scale and design of the reactor. The power of the heat source is typically given in “watts” or “joules per second” (J/s). Accordingly, power employed in the heat source is simply 5-15 percent of a multiple of the LHV and the fuel feed flow rate.

Immediately after powering the heat source, the flows of fuel and oxidant are initiated simultaneously. For the purposes of this invention, the term “essentially simultaneously” means that the flows of fuel and oxidant are initiated within a time period no greater than about 0.2 seconds of each other. Any longer delay in initiating any one of the parameters amounts to “lost time” insofar as the fast start is concerned. In practice, a control processor is programmed to initiate all three parameters simultaneously, that is, as fast as the processor can communicate such demands to the heat source and valves controlling the flows of the fuel and oxidant.

The quantities of oxidant and fuel fed to a hydrogen generator are important factors and best described by an atomic oxygen to carbon ratio (O/C), wherein “O” represents a number of oxygen atoms in the oxidant fed to the reactor and “C” represents a number of carbon atoms in the fuel fed to the reactor. Typically, for a fixed flow of fuel, the flow of oxidant is adjusted to provide the desired O/C ratio. In the cold start process of this invention, at initiation (t=0), the O/C ratio is kept at the higher side of fuel-rich, typically at a ratio between about 0.8/1 and about 1.3/1. Below this range, for a fixed fuel flow, the O/C ratio may be too low to provide for sufficient rapid heat generation through exothermic catalytic oxidation at the catalyst. Above this range, for a fixed fuel flow, the O/C ratio may result in unacceptable over-reaction to near complete oxidation products, i.e., water and carbon dioxide and excessive uncontrolled increase in the catalyst temperature.

During the cold start the total flow of the combined oxidant and fuel flows is generally maintained at a space velocity ranging from about 10,000 h⁻¹ to about 1,000,000 h⁻¹, measured at standard conditions. Below this range, the total mass flow may be too low to provide for sufficient heat generation through exothermic catalytic oxidation. Above this range, total mass flow may conduct too much heat out of the generator with lower fuel efficiency as well.

At the incipient sign of a reaction exotherm, the cold start is completed and the CPOX reaction is self-generating. Accordingly, the heat source is de-energized. The reaction exotherm is measured using any technique standard in the art. In one exemplary embodiment, one or more thermocouples (or resistance temperature detectors) are located on or near the substrate to measure temperature. As an example, a thermocouple can be placed at each of the front face of the substrate, the center of the substrate, and the outlet of the substrate or effluent stream. A rise in temperature, which is typically very rapid, is indicative of the incipient exotherm and generation of hydrogen. On a short time scale of only a few seconds, a thermocouple measurement might be inaccurate due to a response delay inherent in the thermocouple itself. Accordingly, as another exemplary technique, an oxygen sensor is disposed within the effluent stream exiting the hydrogen generator. Oxygen sensors are fast acting, within the time frame of the process invention. As the CPOX process commences, oxygen in the oxidant flow will be depleted. Accordingly, a measurable drop in oxygen content in the effluent stream indicates that reforming is proceeding with accompanying exotherm and hydrogen generation. Either way, a rapid rise in reaction temperature and/or a rapid depletion of oxygen in the effluent stream indicates that hydrogen is being produced and the cold start is complete, as well that hydrogen is available for augmentation of a downstream vehicular internal combustion engine.

More to this point, when the heat source is de-energized, the temperature in the reactor usually needs some stabilization. Thus, the oxidant flow is reduced to accommodate an O/C ratio richer in fuel, namely, an O/C ratio between about 0.3/1 and 0.6/1. By reducing the flow of oxidant, the reaction exotherm is controlled to avoid overheating, a condition that would negatively reduce hydrogen selectivity and catalyst lifetime. Then, after the temperature has stabilized, typically on the order of about 10 to 20 seconds, the oxidant flow is increased gradually to an O/C ratio between about 0.9/1 to 1.5/1 for the duration of operation, the exact range being dependent upon the fuel selected. This condition maintains the catalyst temperature in a steady state operating range between about 800° C. and 1,100° C. Any small quantity of carbon that may be deposited within the reactor during fast start is easily removed during subsequent steady state operation.

It should be appreciated that the hydrogen generator employed in this invention is typically operated under dry catalytic partial oxidation process conditions (dry CPOX) in the absence of co-fed water or steam. Providing for a source of water or steam would be burdensome especially onboard transportation vehicles. Nevertheless, steam is not excluded from this process; and in limited quantity steam could advantageously increase hydrocarbons conversion. Accordingly, if steam is employed, a steam to carbon mole ratio (St/C), given as the moles of steam fed relative to moles of carbon fed to the generator, ranges from 0 to less than about 1.0/1. If steam is employed, it can be introduced with the flow of oxidant, or alternatively, fed through a separate dedicated inlet.

This disclosure is further illustrated by the following examples, which are non-limiting.

### Example 1

Fast start testing was performed on a hydrogen generator comprising a housing containing a metal mesh substrate having a partial oxidation catalyst supported thereon (Precision Combustion, Inc.). The housing was fitted with a fuel inlet, specifically a fuel nozzle-atomizer, an oxidant inlet (nozzle), a mixing zone upstream of the substrate, and an effluent outlet. The metal mesh substrate was wound into a cylindrical coil with an inner channel defining an inner diameter and running longitudinally therethrough. The inner channel was fluidly connected to the upstream mixing zone for thoroughly mixing the fuel and oxidant before contacting the substrate. A glow plug (24 volts rated), acting as heat source was positioned within the inner channel of the coiled mesh, proximate to the inner face of the mesh. Gasoline and air were the selected fuel and oxidant, respectively. The mixture of fuel and air entered the inner channel and then flowed radially through the substrate coil to the reactor outlet. Thermocouples keeping track of temperature were located at the fuel-air inlet, at a mid-point within the catalytic substrate, and at the effluent stream. An oxygen sensor was located at the effluent stream.

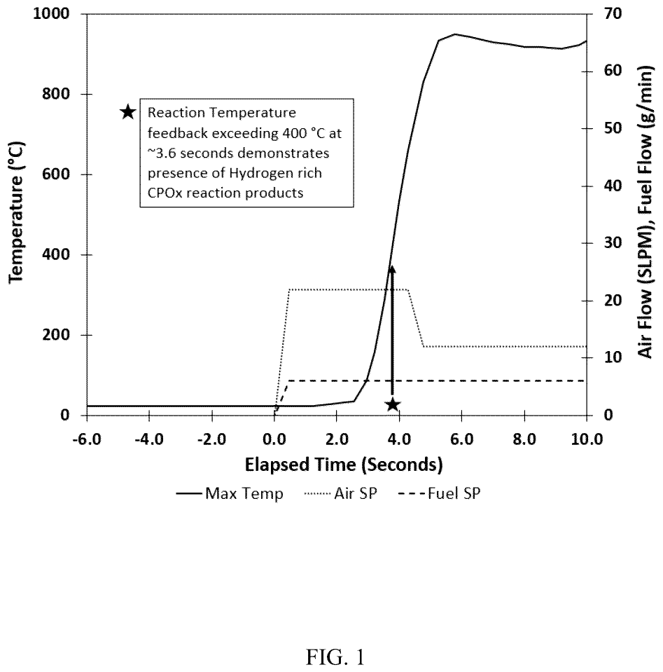

At t=0, the glow plug was energized at 10 percent of power (energy) input to the CPOX reactor based on LHV and feed flow rate of gasoline fuel. The glow plug was operated at 30 volts, providing for an inrush current of 15 amps, resulting in 450 Watts of power to the glow plug, which provided heat to the catalyst-coated mesh coil and the inflowing flows of fuel and air. Immediately with energizing the glow plug, a flow of gasoline (5.95 g/min) and a flow of air (22 SLPM) were commenced simultaneously. The air to gasoline O/C ratio was 0.90/1. As seen in FIG. 1, at t=3.6 seconds after start-up, the temperature within the catalyst reached 400° C. indicative of the CPOX reaction actively proceeding with production of hydrogen. At this point, the cold start was effectively completed. Then, the glow plug was de-energized, and the air flow was dropped to 12 SLPM, resulting in an O/C ratio of 0.49/1, after which the temperature in the generator stabilized. Steady state operating conditions were then implemented at an O/C ratio of 0.9/1 for continuing operation.

### Example 2

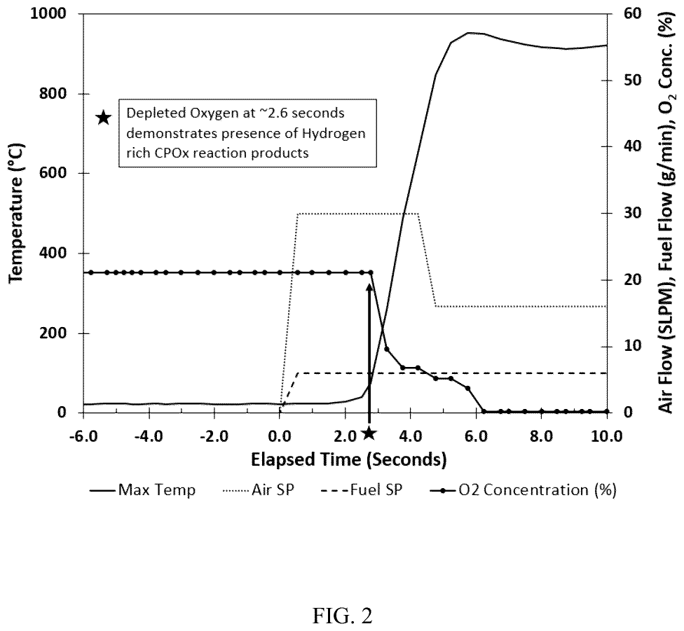

The process of Example 1 was repeated while monitoring an oxygen sensor positioned in the effluent stream of the generator. As seen in FIG. 2, after t=2.6 seconds from the start time, the sensor detected a sharp decrease in oxygen concentration indicating hydrogen production. At this point cold start was completed. The temperature in the generator was then stabilized and steady state operating conditions were implemented in the manner described in Example 1 for continuing operation. Hydrogen thusly generated from the fast cold-start condition can be readily supplied to a vehicular internal combustion engine for hydrogen augmentation of the engine, which results in higher engine efficiency and lower hydrocarbon and NOx emissions.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description but is only limited by the scope of the appended claims.

1. A process of starting a hydrogen generator from cold conditions comprising:
(a) providing a catalytic partial oxidation reactor having disposed therein a substrate having a partial oxidation catalyst supported thereon; and further comprising a heat source disposed in proximity to a front face of the substrate;
(b) energizing the heat source at a power equal to 5 to 15 percent of a power (energy) input to the reactor based on a Lower Heating Value (LHV) and feed flow rate of a selected fuel;
(c) essentially simultaneously with step (b) initiating a flow of an oxidant and a flow of the selected fuel at an O/C ratio between about 0.8/1 and 1.3/1; and
(d) upon observation of an incipient exotherm indicative of generating hydrogen, de-energizing the heat source.

2. The process in accordance with claim 1 wherein the substrate comprises a metal mesh.

3. The process in accordance with claim 1 wherein the metal mesh has an ultra-short-channel-length ranging from 25 microns to 500 microns.

4. The process in accordance with claim 1 wherein the partial oxidation catalyst is selected from Group VIII transition metals of the Periodic Table.

5. The process in accordance with claim 1 wherein the substrate is provided in the shape of a cylindrical coiled mesh defining an inner face of inner diameter and an outer face of a larger outer diameter, along the length of the substrate.

6. The process in accordance with claim 5 wherein the heat source is disposed within a space defined by the inner diameter and length of the cylindrical coiled mesh.

7. The process in accordance with claim 1 wherein the heat source is a glow plug.

8. The process in accordance with claim 1 wherein the cold conditions are at a temperature between −40° C. and +46° C.

9. The process in accordance with claim 1 wherein the heat source is energized to a power equal to 8 to 12 percent of a power (energy) input to the reactor based on the Lower Heating Value (LHV) and feed flow rate of the selected fuel.

10. The process in accordance with claim 1 wherein the oxidant flow is initiated within 0.2 second of initiation of the fuel flow.

11. The process in accordance with claim 1 wherein start up is accomplished in less than 6 seconds.

12. The process in accordance with claim 1 wherein start up is accomplished in less than 5 seconds.

13. The process in accordance with claim 1 wherein start up is accomplished in a time between 1 and 4 seconds.

14. The process in accordance with claim 1 wherein the incipient exotherm is measured by means of at least one thermocouple disposed on or near the substrate or measured by means of an oxygen sensor disposed in an effluent stream at the outlet of the hydrogen generator (catalytic partial oxidation reactor).

15. The process in accordance with claim 1 wherein after reaching the incipient exotherm, the flow of oxidant is decreased to an O/C ratio between 0.3/1 and 0.6/1 to stabilize temperature.

16. The process in accordance with claim 15 wherein after temperature stabilizes, the flow of the oxidant is increased to a steady state operating O/C ratio between 0.9/1 and 1.5/1 to maintain a catalyst temperature between 800° C. and 1,000° C.

17. The process in accordance with claim 1 wherein the substrate is configured as a coil of cylindrical shape characterized by an outer diameter and characterized by an inner diameter defining an interior void space; further wherein the heat source is disposed within the interior void space defined by the inner diameter of the cylindrically coiled substrate.

18. The process in accordance with claim 17 wherein the fuel and oxidant flow from an inlet at the inner diameter of the cylindrically coiled substrate, radially through the substrate, to an outlet at the outer diameter of the cylindrically coiled substrate.
